(19) United States
(12) Patent Application Publication
(10) Pub. No.: US 2025/0087725 A1
(43) Pub. Date: Mar. 13, 2025

(54) METHOD FOR OPERATING A FUEL CELL SYSTEM, AND A CONTROL UNIT

(71) Applicant: Robert Bosch GmbH, Stuttgart (DE)

(72) Inventors: Christophe Billmann, Stuttgart (DE); Christopher Bruns, Sindelfingen (DE); Timo Bosch, Renningen (DE); Tobias Falkenau, Esslingen (DE)

(21) Appl. No.: 18/729,017

(22) PCT Filed: Jan. 18, 2023
(86) PCT No.: PCT/EP2023/051083

§ 371 Date: Jul. 15, 2024

(30) Foreign Application Priority Data
Jan. 20, 2022 (DE) 10 2022 200 641.0

(51) Int. Cl. H01M 8/04089; H01M 8/04119; H01M 8/0432; H01M 8/04746; H01M 8/04791

(52) U.S. Cl. CPC H01M 8/04097; H01M 8/04179; H01M 8/04328; H01M 8/04343; H01M 8/04753; H01M 8/04761; H01M 8/04798

(57) ABSTRACT

The invention relates to a method for operating a fuel cell system (1) in which anode gas emerging from a fuel cell stack (2) is recirculated via an anode circuit (3) by means of an electrically operated hydrogen blower (4) that is integrated into the anode circuit (3), and in which nitrogen-enriched anode gas is intermittently discharged by selectively opening a purge valve (5) that is integrated into the anode circuit (3). According to the invention, the method comprises the following steps:
measuring the temperature at at least one temperature measurement point (6), said temperature being representative of the temperature of the hydrogen blower (4),
comparing the measured temperature with a predefined threshold value, and
switching to a more hydrogen-rich operation of the fuel cell system (1) if the threshold value is overshot.

The invention furthermore relates to a control unit (8) for carrying out the steps of the method according to the invention.

### BACKGROUND

The invention relates to a method for operating a fuel cell system. Furthermore, a control unit for executing the method or individual method steps is proposed.

Hydrogen-based fuel cell systems use oxygen to convert hydrogen into electrical energy while generating heat and water. The fuel cell consists of an anode, which is supplied with hydrogen, a cathode, which is supplied with air, and a proton-permeable membrane placed in between. Several such fuel cells are stacked in practical applications in order to increase the electrical voltage generated.

A systemic approach to supplying fuel cells with hydrogen has been established in which the anode exhaust gas, which is still rich in hydrogen, is fed back to the anode together with fresh hydrogen using gas delivery units. This is referred to as recirculation. Jet pumps and/or electrically operated hydrogen blowers are used as gas delivery units.

Due to diffusion through the fuel cell stack and/or impurities in the fuel, recirculated anode gas is enriched with nitrogen over time. The nitrogen concentration is regulated through selective purging. A valve is opened for this purpose, the so-called purge valve.

An electrically powered hydrogen blower generates waste heat when recirculating anode gas. The waste heat or heat must be dissipated in order to prevent the blower from overheating, particularly in the area of its control electronics and/or its sealing points. The heat can be dissipated by selectively cooling of the emerging anode exhaust gas as well as by convective losses and/or flow losses to the environment.

However, the hydrogen blower can overheat due to high temperatures in the immediate vicinity of the hydrogen blower and/or due to the high electrical power required and the associated increased waste heat. The electrical output increases if a) the nitrogen concentration increases, b) liquid water is recirculated, c) larger quantities of anode gas are recirculated, and/or d) the jet pump contributes less to the recirculation.

In the event of potential overheating, reducing the system output is not a solution due to the interaction of the hydrogen blower and jet pump. This is because the jet pump contributes less to recirculation at reduced system output than at full output, so that the hydrogen blower has to compensate for the reduced output of the jet pump. In addition, the system output of a fuel cell system cannot usually be freely selected.

### SUMMARY

The invention is therefore concerned with the task of preventing overheating of an electrically operated hydrogen blower, which is used in a fuel cell system for recirculating anode gas in an anode circuit, as effectively as possible. The aim is to increase the service life of a hydrogen blower in this way.

In order to solve this problem, the method having the features of the disclosure is proposed. In addition, a control unit for executing steps of the method is specified.

A method is proposed for operating a fuel cell system in which anode gas emerging from a fuel cell stack is recirculated via an anode circuit with the aid of an electrically operated hydrogen blower integrated in the anode circuit and in which anode gas enriched with nitrogen is intermittently discharged by selectively opening a purge valve integrated in the anode circuit. According to the invention, the method comprises the following steps:
measuring the temperature at at least one temperature measurement point (6), said temperature being representative of the temperature of the hydrogen blower (4),
comparing the measured temperature with a predefined threshold value, and
switching to a more hydrogen-rich operation of the fuel cell system (1) if the threshold value is overshot.

Switching the fuel cell system to hydrogen-rich operation means that the anode gas is easier to recirculate. The hydrogen blower is therefore less heavily used, so that less waste heat is produced during operation of the hydrogen blower. In this way, overheating of the hydrogen blower can be effectively prevented without having to reduce the delivery rate of the hydrogen blower and thus the performance of the fuel cell system.

In order to switch to a more hydrogen-rich operation of the fuel cell system, it is proposed to increase the hydrogen concentration of the anode gas selectively by temporarily opening the purge valve. Nitrogen-enriched anode gas is then discharged via the purge valve and replaced with fresh hydrogen. In this way, the hydrogen concentration of the anode gas can be selectively increased.

Fresh hydrogen is preferably introduced into the anode circuit with the aid of a hydrogen metering valve. This can be followed by a jet pump for passive recirculation of anode gas. The quantity of hydrogen metered in with the aid of the hydrogen metering valve can then be used to operate the jet pump. The operation of the jet pump in turn reduces the load on the hydrogen blower so that it produces less waste heat.

Alternatively or additionally, it is suggested that the rotational speed of the hydrogen blower be reduced. This measure also helps to relieve the hydrogen blower so that overheating of the hydrogen blower can be prevented. Whether the rotational speed of the hydrogen blower can be reduced depends in particular on the current system operating point. Moreover, the rotational speed cannot be reduced at will, as a certain minimum rotational speed is required to prevent a hydrogen undersupply.

Furthermore, it is proposed that the temperature at the at least one temperature measurement point is detected with the aid of a temperature sensor. In particular, the temperature sensor can be arranged in or on a housing of the hydrogen blower so that the measured temperature is representative of the temperature of the blower.

The comparison of the measured temperature with the predefined threshold value is preferably carried out with the aid of a control unit in which the threshold value is stored. The control unit is preferably connected to the temperature sensor in a data-transmitting manner so that the measured data from the temperature sensor can be made available to the control unit.

Advantageously, the purge valve and/or the hydrogen blower are controlled via the control unit. This is because if the comparison of the measured temperature with the threshold value shows that it has been exceeded, the control unit can be used to switch directly to a more hydrogen-rich mode. For example, the purge valve can be opened to increase the hydrogen concentration of the anode gas. The rotational speed of the hydrogen blower can also be reduced.

In order to solve the task mentioned at the beginning, a control unit is also proposed which is set up to carry out steps of a method according to the invention. In particular, the control unit can be used to compare the measured temperature with a threshold value that is stored in the control unit for this purpose. Furthermore, if the threshold value is overshot, the control unit can be used to open the purge valve and/or reduce the rotational speed of the hydrogen blower.

### BRIEF DESCRIPTION OF THE DRAWINGS

The method according to the invention and its advantages are explained in more detail below with reference to the accompanying drawings. Shown are:

FIG. 1 a schematic illustration of a fuel cell system which can be operated according to the method according to the invention, and

FIG. 2 block diagram illustrating the method sequence.

### DETAILED DESCRIPTION

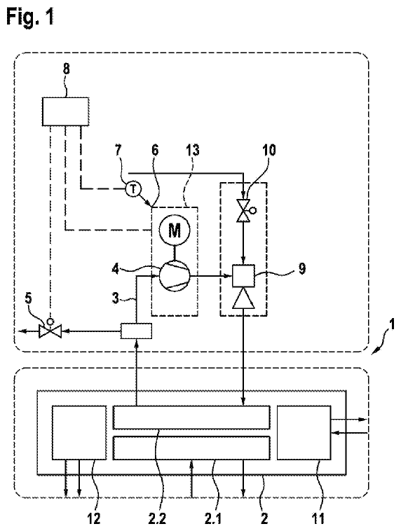

FIG. 1 shows a fuel cell system 1 with a fuel cell stack 2, which has a cathode 2.1 and an anode 2.2. The fuel cell stack 2 is connected to a cooling circuit 11 to dissipate the heat generated in the process. In addition, the fuel cell stack 2 has electrical connections 12 via which the generated electrical power is tapped.

During operation of the fuel cell system 1, the anode 2.2 of the fuel cell stack 2 is supplied with anode gas via an anode circuit 3. The anode gas is made up of fresh hydrogen and recirculated depleted hydrogen. The fresh hydrogen is fed into the anode circuit 3 with the aid of a hydrogen metering valve 10. The depleted hydrogen is recirculated passively with the aid of a jet pump 9 and actively with the aid of a hydrogen blower 4 in the anode circuit 3. The hydrogen blower 4 is operated electrically or by an electric motor.

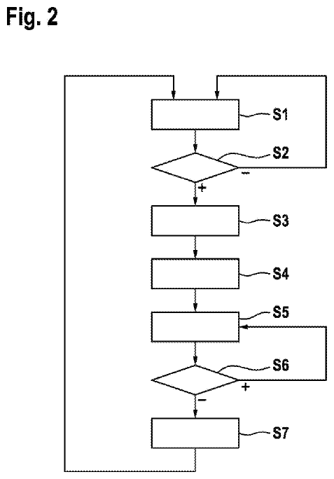

When the hydrogen blower 4 is in operation, it generates waste heat so that the hydrogen blower 4 can overheat. There is a particular risk of overheating if high electrical power is required and/or the ambient temperatures are very high. In order to prevent overheating, the fuel cell system 1 can be operated according to the method of the invention described below with reference to FIG. 2.

In step S1 of the method, the temperature is measured at a predefined temperature measurement point 6 using a temperature sensor 7. In the fuel cell system 1 shown in FIG. 1, the temperature measurement point 6 and the temperature sensor 7 are located on a housing 13 of the hydrogen blower 4, so that the measured temperature is representative of the temperature of the hydrogen blower 4. In the following step S2, the measured temperature is compared with a predefined threshold value, which is preferably stored in a control unit 8 of the fuel cell system 1 (see FIG. 1). The measurement data from the temperature sensor 7 is then transmitted to the control unit 8 for evaluation. If the control unit 8 comes to the conclusion that the threshold value is not exceeded (−), only step S1 is repeated in order to monitor the temperature at the temperature measurement point 6. However, if the comparison shows that the threshold value is exceeded (+), the system switches to a more hydrogen-rich mode in step S3 of the process. For this purpose, a purge valve 5 integrated in the anode circuit 3 is opened (see FIG. 1) so that depleted hydrogen is discharged from the anode circuit 3 and replaced by fresh hydrogen. Anode gas, which has a higher hydrogen concentration, can be recirculated more easily, so that the hydrogen blower 4 is relieved and produces less waste heat. Optionally, in a further step S4, the rotational speed of the hydrogen blower 4 can be reduced for the same purpose.

In step S5, the temperature at the temperature measurement point 6 is then measured again and compared with the threshold value in step S7. If the comparison shows that the temperature is still too high (+), purge is continued. If the rotational speed of the hydrogen blower 4 has been reduced, this operation is maintained. If the comparison shows that the temperature is no longer too high (−), purge valve 5 can be closed again in step S7. If the rotational speed of the hydrogen blower 4 has been reduced, it can be increased again.

1. A method for operating a fuel cell system (1) in which anode gas emerging from a fuel cell stack (2) is recirculated via an anode circuit (3) by means of an electrically operated hydrogen blower (4) that is integrated into the anode circuit (3), and in which nitrogen-enriched anode gas is intermittently discharged by selectively opening a purge valve (5) that is integrated into the anode circuit (3),
wherein the method comprises the following steps:
measuring the temperature at at least one temperature measurement point (6), said temperature being representative of the temperature of the hydrogen blower (4),
comparing the measured temperature with a predefined threshold value, and
switching to a more hydrogen-rich operation of the fuel cell system (1) if the threshold value is overshot.

2. The method according to claim 1,
wherein the hydrogen concentration of the anode gas is selectively increased by temporarily opening the purge valve (5).

3. The method according to claim 1,
wherein the rotational speed of the hydrogen blower (4) is reduced.

4. A method according to claim 1,
wherein the temperature at the at least one temperature measurement point (6) is detected with the aid of a temperature sensor (7).

5. The method according to claim 1,
wherein the comparison of the measured temperature with the predefined threshold value is carried out with the aid of a control unit (8) in which the threshold value is stored.

6. The method according to claim 5,
wherein the purge valve (5) and/or the hydrogen blower (4) are controlled via the control unit (8).

7. A control unit (8) configured to carry out steps of a method according to claim 1.
